(19) United States
(12) Patent Application Publication
(10) Pub. No.: US 2014/0127564 A1
(43) Pub. Date: May 8, 2014

(54) NEGATIVE ELECTRODE FOR RECHARGEABLE LITHIUM BATTERY AND RECHARGEABLE LITHIUM BATTERY INCLUDING SAME

(71) Applicant: Samsung SDI Co., Ltd., Yongin-si (KR)

(72) Inventors: Jeong-Woo Han, Yongin-si (KR); Young-Kee Kim, Yongin-si (KR); Jung-Woo An, Yongin-si (KR); Sumihito Ishida, Yongin-si (KR)

(73) Assignee: Samsung SDI Co., Ltd., Yongin-si (KR)

(21) Appl. No.: 13/953,714

(22) Filed: Jul. 29, 2013

Related U.S. Application Data
(60) Provisional application No. 61/723,661, filed on Nov. 7, 2012.

(51) Int. Cl. H01M 4/583

(52) U.S. Cl. CPC H01M 4/583
USPC 429/211

(57) ABSTRACT

A negative electrode for a rechargeable lithium battery includes a current collector and a negative active material layer including a negative active material on the current collector. A rechargeable lithium battery includes the negative electrode. The negative active material includes amorphous carbon with an average aspect ratio of 1.1 to 6, included in an amount of about 55.5 wt % to about 99.5 wt % based on the total weight of the negative active material layer.

### CROSS-REFERENCE TO RELATED APPLICATION

This application claims priority to and the benefit of U.S. Provisional Application No. 61/723,661, filed in the U.S. Patent and Trademark Office on Nov. 7, 2012, the entire content of which is incorporated herein by reference.

### BACKGROUND

1. Field

This disclosure relates to a negative electrode for a rechargeable lithium battery and a rechargeable lithium battery including the same.

2. Description of the Related Art

Researchers are studying rechargeable batteries that may be applied to an ISG (Integrated Starter & Generator) system used for the engine of a vehicle.

An ISG system is a system integrating a power generator and a motor. Specifically, an ISG system is an engine control system that stops the engine when the engine runs idle for a predetermined (or set) time, and when a brake pedal is released or when an accelerator pedal is stepped on, an Idle Stop & Go function for restarting the engine is performed.

Among the rechargeable batteries that may be applied to an ISG system is an AGM battery, which has a large volume compared with its capacity, and may have a shortened cycle-life as a result of repeated charge and discharge.

In order to overcome these problems, a rechargeable lithium battery having a small volume and high energy density has been considered for an ISG system. The rechargeable battery should have high charge and discharge rates (C-rate) in order to be used in an ISG system. Therefore, rechargeable lithium batteries having a low self-discharge rate and high charge and discharge rates have been studied.

### SUMMARY

Aspects of embodiments of the present invention are directed toward a negative electrode for a rechargeable lithium battery having high cycle-life and output characteristics. Another aspect is directed toward a rechargeable lithium battery including the negative electrode.

According to one embodiment, a negative electrode for a rechargeable lithium battery includes a current collector and a negative active material layer on the current collector. The negative active material layer includes a negative active material including amorphous carbon having an average aspect ratio of 1.1 to 6. The amorphous carbon is included in an amount of about 55.5 wt % to about 99.5 wt % based on the total weight of the negative active material layer.

In some embodiments, the average aspect ratio of the amorphous carbon is in a range of 3 to 5. In some embodiments, the amorphous carbon is included in an amount of about 70.0 wt % to about 95.0 wt % based on the total weight of the negative active material layer.

The amorphous carbon may have an interplanar distance d(002) in a range of 3.10 Å to 3.55 Å. In some embodiments, the interplanar distance d(002) of the amorphous carbon is in a range of 3.40 Å to 3.55 Å.

The amorphous carbon may have a lattice constant (L_{c}) in a range of 10 Å to 50 Å. In some embodiments, the lattice constant (L_{c}) of the amorphous carbon is in a range of 10 Å to 30 Å.

The amorphous carbon may have an average particle diameter D(50) in a range of 5 μm to 20 μm. In some embodiments, the average particle diameter (D(50)) of the amorphous carbon is in a range of 7 μm to 15 μm.

The amorphous carbon may be soft carbon.

The negative active material layer may further include a conductive material and a binder.

According to one embodiment, a lithium battery includes a negative electrode including a current collector, a negative active material layer on the current collector; a positive electrode including a positive active material; and an electrolyte impregnating the negative electrode and the positive electrode. The negative active material layer includes a negative active material comprising amorphous carbon having an average aspect ratio of 1.1 to 6. The amorphous carbon is included in an amount of about 55.5 wt % to about 99.5 wt % based on the total weight of the negative active material layer.

The positive active material may include a material selected from a lithium composite oxide, activated carbon, or combinations thereof.

The average aspect ratio of the amorphous carbon may be in a range of 3 to 5.

The amorphous carbon may be included in an amount of about 70.0 wt % to about 95.0 wt % based on the total weight of the negative active material layer.

The amorphous carbon may have an interplanar distance d(002) in a range of 3.10 Å to 3.55 Å. The amorphous carbon may have a lattice constant (L_{c}) in a range of 10 Å to 50 Å.

The amorphous carbon may have an average particle diameter (D(50)) in a range of 5 μm to 20 μm.

The amorphous carbon may be soft carbon.

The negative active material layer may further include a conductive material and a binder.

According to embodiments of the present invention, a lithium battery including the above described negative active material may have improved cycle-life and output characteristics.

### BRIEF DESCRIPTION OF THE DRAWINGS

FIG. 1 is a schematic view showing a rechargeable lithium battery according to one embodiment.

FIG. 2 is a SEM photograph of a negative active material according to Example 1.

FIG. 3 is a SEM photograph of a negative active material according to Example 3.

FIG. 4 is a SEM photograph of a negative active material according to Example 5.

FIG. 5 is a SEM photograph of a negative active material according to Comparative Example 1.

FIG. 6 is a graph showing cycle-life characteristics of rechargeable lithium battery cells according to Example 1 and Comparative Example 1.

FIG. 7 is a graph showing output characteristics of the rechargeable lithium battery cells according to Example 1 and Comparative Example 1.

### DETAILED DESCRIPTION

Embodiments of the invention will hereinafter be described in detail. However, these embodiments are examples, and this disclosure is not limited thereto.

According to one embodiment, a negative electrode for a rechargeable lithium battery includes a current collector and a negative active material layer including a negative active material formed on the current collector. The negative active material includes scale-shaped amorphous carbon. According to some embodiments, the negative active material is included in the negative active material layer within a set range and thus, has high cycle-life and output characteristics.

In particular, the amorphous carbon may have a scale-shape expressed by an aspect ratio of a width relative to a length. In other words, when the width of the scale-shape is represented by a, and the length is represented by b, a ratio of the width (a) relative to (b) is an aspect ratio (a/b). When the aspect ratio (a/b) is 1, the amorphous carbon has a spherical shape.

According to one embodiment, the amorphous carbon used as the negative active material may have an aspect ratio (a/b) ranging from 1.1 to 6 (e.g., in a range of 1.1 to 6). In some embodiments, the aspect ratio (a/b) may be in a range of 3 to 5. According to some embodiments, when the amorphous carbon has an aspect ratio (a/b) within the range, the negative active material including the amorphous carbon has a shorter path through which electrons flow, thereby decreasing resistance. In addition, in view of this aspect ratio, binder may be included in a relatively smaller amount and thus, deterioration of electrical conductivity resulting from the binder is prevented or reduced. Accordingly, the negative electrode has less internal resistance and thus, may realize a rechargeable lithium battery having high cycle-life and output characteristics.

The negative active material layer may further include a conductive material and a binder in addition to the negative active material. Herein, the negative active material may be included in an amount in a range of 55.5 to 99.5 wt % based on the total weight of the negative active material layer, and in some embodiments, the negative active material may be included in an amount in a range of 70.0 to 95.0 wt % based on the total weight of the negative active material layer. In some embodiments, when amorphous carbon with the above described aspect ratio is used as the negative active material, the negative electrode maintains high electrical conductivity, and a rechargeable lithium battery including the negative electrode has high cycle-life and output characteristics.

The amorphous carbon may have an interplanar distance d(002) in a range of 3.10 to 3.55 Å. In some embodiments, the amorphous carbon may have an interplanar distance d(002) in a range of 3.20 to 3.50 Å, and in still other embodiments, the amorphous carbon may have an interplanar distance d(002) in a range of. 3.40 to 3.50 Å. In addition, the amorphous carbon may have a lattice constant L_{c} in a range of 10 to 50 Å. In some embodiments, the amorphous carbon may have a lattice constant L_{c} in a range 10 to 30 Å, and in still other embodiments, the amorphous carbon may have a lattice constant L_{c} in a range of 15 to 25 Å. In some embodiments, when the amorphous carbon has an interplanar distance d(002) and a lattice constant L_{c}within these ranges, a rechargeable lithium battery having high cycle-life and output characteristics is realized.

The amorphous carbon may have an average particle diameter D(50) in a range of 5 to 20 μm. In some embodiments, the amorphous carbon may have an average particle diameter D(50) in a range of 7 to 15 μm. The average particle diameter of the amorphous carbon may be measured by transmitting a laser in a solution with an amorphous carbon sample dispersed therein to determine diameter. Herein, the D(50) indicates a diameter of particles corresponding to 50 volume % of cumulative volume in a particle diameter distribution. In some embodiments, when the amorphous carbon has an average particle diameter D(50) within this range, a rechargeable lithium battery having high cycle-life and output characteristics is realized.

The amorphous carbon may be soft carbon. The soft carbon may be a carbon material having a layered-structure that is formed by heat treatment. The heat treatment may cause graphite particles to aggregate in an orderly manner, forming the layered-structure.

Amorphous carbon having the above described aspect ratio may be obtained using a grinding process or any other suitable process. The ground amorphous carbon may be classified according to its size and form, and then analyzed using SEM photographs to determine the aspect ratio.

The conductive material of the negative active material layer is used to improve conductivity of the electrode. Any electrically conductive material may be used as the conductive material unless it causes a chemical change. Examples of the conductive material include a carbon-based material such as natural graphite, artificial graphite, carbon black, acetylene black, ketjen black, a carbon fiber, and/or the like; a metal-based material such as a metal powder or a metal fiber made of copper, nickel, aluminum, silver, and/or the like; a conductive polymer such as a polyphenylene derivative; or a mixture thereof.

The binder improves binding properties of positive active material particles with one another and with the current collector. Examples of the binder include polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but the binder is not limited thereto.

In general, a binder for forming a negative active material layer tends to hinder electric flow. However, when amorphous carbon having an aspect ratio within the above described range is used to form a negative active material layer, according to one embodiment, the negative active material layer has a decreased electric flow path, and thus, the binder does not significantly deteriorate the electrical conductivity of the negative active material.

The negative electrode may be fabricated by mixing the negative active material, the conductive material, and the binder in a solvent to prepare a negative active material layer composition, and applying the negative active material layer composition on the current collector. The solvent may include N-methylpyrrolidone or the like, but it is not limited thereto.

The current collector may be a copper foil.

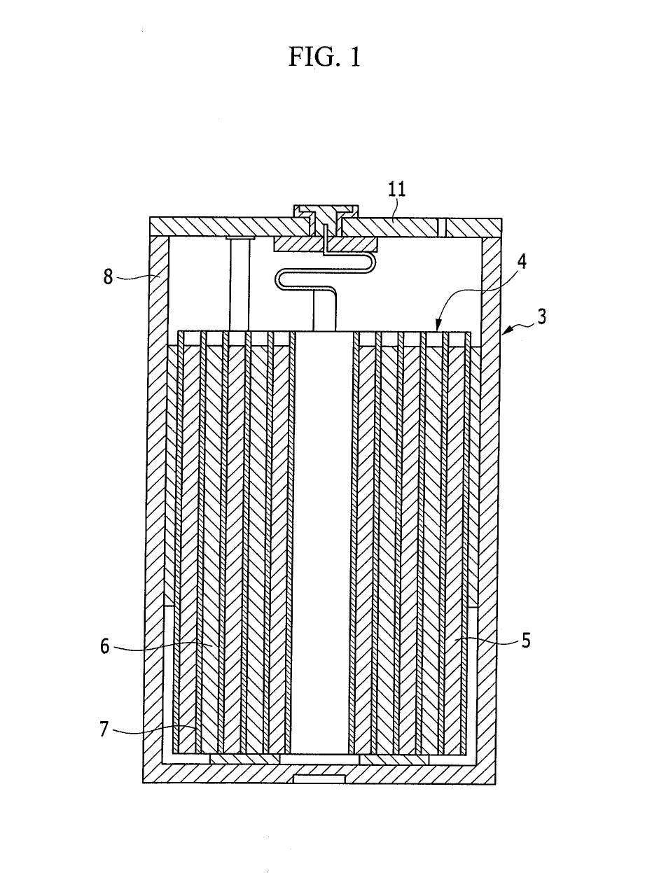

Hereinafter, a rechargeable lithium battery including the negative electrode is illustrated by referring to FIG. 1.

FIG. 1 is a schematic view of a rechargeable lithium battery according to one embodiment.

Referring to FIG. 1, the rechargeable lithium battery 3 is a prismatic battery including an electrode assembly 4 including a positive electrode 5, the above-described negative electrode 6, and a separator 7 interposed between the positive electrode 5 and negative electrode 6 in a battery case 8, an electrolyte solution injected through an upper part of the battery case 8, and a cap plate 11 sealing the battery case. The rechargeable lithium battery according to one embodiment is not limited to a prismatic battery and may be any operable battery. For the rechargeable battery may be a cylindrical, coin-shape, or pouch-shape battery.

The positive electrode 5 includes a current collector and a positive active material layer disposed on the current collector. The positive active material layer includes a positive active material, a binder, and optionally, a conductive material.

The current collector may be Al (aluminum), but it is not limited thereto.

The positive active material may include at least one selected from a lithium composite oxide and activated carbon.

The lithium composite oxide may include a composite oxide including lithium and at least one selected from cobalt, manganese, or nickel. In particular, the following lithium-containing compounds may be used:

LiₐA_{1-b}B_{b}D₂ (wherein 0.90≦a≦1.8 and 0≦b≦0.5); LiₐE_{1-b}B_{b}O_{2-c}D_{c} (wherein 0.90≦a≦1.8, 0≦b≦0.5, and 0≦c≦0.05); LiE_{2-b}B_{b}O_{4-c}D_{c} (wherein 0≦b≦0.5 and 0≦c≦0.05); LiₐNi_{1-b-c}Co_{b}B_{c}D_{α} (wherein 0.90≦a≦1.8, 0≦b≦0.5, 0≦c≦0.05, and 0<α<2); LiₐNi_{1-b-c}Co_{b}B_{c}O_{2-α}F_{α} (wherein 0.90≦a≦1.8, 0≦b≦0.5, 0≦c≦0.05, and 0<α<2); LiₐNi_{1-b-c}Co_{b}B_{c}O_{2-α}F₂ (wherein 0.90≦a≦1.8, 0≦b≦0.5, 0≦c≦0.05, and 0<α<2); LiₐNi_{1-b-c}Mn_{b}B_{c}D_{α} (wherein 0.90≦a≦1.8, 0≦b≦0.5, 0≦c≦0.05, and 0<α<2); LiₐNi_{1-b-c}Mn_{b}B_{c}O_{2-α}F_{α} (wherein 0.90≦a≦1.8, 0≦b≦0.5, 0≦c≦0.05, and 0<α<2); LiₐNi_{1-b-c}Mn_{b}B_{c}O_{2-α}F₂ (wherein 0.90≦a≦1.8, 0≦b≦0.5, 0≦c≦0.05, and 0<α<2); LiₐNi_{b}E_{c}G_{d}O₂ (wherein 0.90≦a≦1.8, 0≦b≦0.9, 0≦c≦0.5, and 0.001≦d≦0.1); LiₐNi_{b}Co_{c}Mn_{d}GₑO₂ (wherein 0.90≦a≦1.8, 0≦b≦0.9, 0≦c≦0.5, 0≦d≦0.5, and 0.001≦e≦0.1); LiₐNiG_{b}O₂ (wherein 0.90≦a≦1.8 and 0.001≦b≦0.1); LiₐCoG_{b}O₂ (wherein 0.90≦a≦1.8 and 0.001≦b≦0.1); LiₐMnG_{b}O₂ (wherein 0.90≦a≦1.8 and 0.001≦b≦0.1); LiₐMn₂G_{b}O₄ (wherein 0.90≦a≦1.8 and 0.001≦b≦0.1); QS₂; LiQS₂; V₂O₅; LiV₂O₅; LiIO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

The lithium composite oxide may have a coating layer on the surface or be mixed with a compound having a coating layer. The coating layer may include at least one coating element compound selected from an oxide of a coating element, a hydroxide of a coating element, an oxyhydroxide of a coating element, an oxycarbonate of a coating element, or a hydroxyl carbonate of a coating element. The compounds for the coating layer may be amorphous or crystalline. The coating element for the coating layer may include Mg, Al, Co, K, Na, Ca, Si, Ti, V, Sn, Ge, Ga, B, As, Zr, or a mixture thereof. The coating layer may be formed using a method that has no negative influence on the properties of the positive active material. For example, the method may be spray coating, dipping, or any other suitable method, but they are not illustrated in more detail, because they are known to those of skill in the art.

The activated carbon is a carbon-based material having high porosity, a large specific surface area, and high adsorption capability. The activated carbon may be an amorphous carbon in which graphite-shaped planar crystallites are complicatedly combined.

The binder improves binding properties of the positive active material particles to one another and to the current collector. Examples of the binder include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like. But the binder is not limited thereto.

The conductive material is used in order to improve conductivity of an electrode. Any electrically conductive material may be used as a conductive material unless it causes a chemical change. Examples of the conductive material include a carbon-based material such as natural graphite, artificial graphite, carbon black, acetylene black, ketjen black, a carbon fiber, and/or the like; a metal-based material such as a metal powder or a metal fiber made of copper, nickel, aluminum, silver, and/or the like; a conductive polymer such as a polyphenylene derivative; or a mixture thereof.

The positive electrode may be manufactured by mixing the positive active material, the binder, and the conductive material in a solvent to prepare a positive active material layer composition, and applying the composition on the current collector. The solvent may include N-methylpyrrolidone or the like, but it is not limited thereto.

The electrolyte solution includes a non-aqueous organic solvent and a lithium salt.

The non-aqueous organic solvent serves as a medium for transmitting ions taking part in the electrochemical reaction of the battery. The non-aqueous organic solvent may be selected from a carbonate-based solvent, an ester-based solvent, an ether-based solvent, a ketone-based solvent, an alcohol-based solvent, and/or an aprotic solvent.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), and/or the like.

When chain carbonate compounds and cyclic carbonate compounds are mixed, an organic solvent having high dielectric constant and low viscosity may be provided. In some embodiments, a cyclic carbonate and a chain carbonate are mixed together in a volume ratio ranging from about 1:1 to 1:9.

The ester-based solvent may include, for example, n-methylacetate, n-ethylacetate, n-propylacetate, methylacetate, methylpropionate, ethylpropionate, γ-butyrolactone, decanolide, valerolactone, mevalonolactone, caprolactone, and/or the like. The ether-based solvent may include, for example, dibutyl ether, tetraglyme, diglyme, dimethoxyethane, 2-methyltetrahydrofuran, tetrahydrofuran, and/or the like. The ketone-based solvent may include, for example, cyclohexanone and/or the like. The alcohol-based solvent may include, for example ethyl alcohol, isopropyl alcohol, and/or the like.

The non-aqueous organic solvent may be used singularly or in a mixture. When the organic solvent is used in a mixture, the mixture ratio can be controlled in accordance with a desired battery performance.

The non-aqueous electrolyte may further include an overcharge inhibitor additive such as ethylenecarbonate, pyrocarbonate, and/or the like.

The lithium salt is dissolved in the organic solvent. The lithium salt supplies lithium ions in the battery and improves lithium ion transportation between positive and negative electrodes therein.

The lithium salt may include LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂), (where x and y are natural numbers), LiCl, LiI, LiB(C₂O₄)₂ (lithium bis(oxalato)borate, LiBOB), or a combination thereof.

The lithium salt may be used in a concentration of about 0.1 M to about 2.0 M. In some embodiments, when the lithium salt is included within the above concentration range, an electrolyte has high performance and improved lithium ion mobility as a result of desired electrolyte conductivity and viscosity.

The separator 7 may include any materials commonly used in lithium batteries as long as it separates the negative electrode from the positive electrode and provides a passage for lithium ions. In other words, the separator 7 may have a low resistance to ion transportation and also be easily impregnated with the electrolyte. For example, the separator may be selected from glass fiber, polyester, TEFLON (tetrafluoroethylne), polyethylene, polypropylene, polytetrafluoroethylene (PTFE), or a combination thereof. It may be non-woven fabric or woven fabric. For example, a polyolefin-based polymer separator such as polyethylene, polypropylene, or the like may be used as a separator for a lithium ion battery. In order to ensure or improve the heat resistance and/or mechanical strength, a coated separator including a ceramic component or a polymer material may be used. The separator may be a single layer or have a multi-layered structure.

The rechargeable lithium battery may be usefully applied to an ISG (Integrated Starter & Generator) system for an auto engine.

The following examples illustrate the present invention in more detail. These examples, however, should not in any sense be interpreted as limiting the scope of the present invention.

### Fabrication of Negative Electrode

### EXAMPLE 1

88 wt % of amorphous carbon (SC1 manufactured by GS Energy Co., Ltd., Korea) with an aspect ratio (a/b) of 4, 7 wt % of Denka black, 2 wt % of carboxylmethyl cellulose, and 3 wt % of styrene-butadiene rubber were mixed, and the mixture was dispersed into N-methyl-2-pyrrolidone, thereby preparing a composition for a negative active material layer. Next, the composition for a negative active material layer was coated on a copper foil, dried, and compressed, thereby fabricating a negative electrode.

### EXAMPLE 2

A negative electrode was fabricated according to the same method as Example 1 except for using 80 wt % of the amorphous carbon (SC1 manufactured by GS Energy Co., Ltd.) having an aspect ratio (a/b) of 4, 14 wt % of Denka black, 3 wt % of carboxylmethyl cellulose, and 3 wt % of a styrene-butadiene rubber.

### EXAMPLE 3

A negative electrode was fabricated according to the same method as Example 1 except for using 88 wt % of the amorphous carbon (SC2 manufactured by GS Energy Co., Ltd.) having an aspect ratio (a/b) of 1.86, 7 wt % of Denka black, 2 wt % of carboxylmethyl cellulose, and 3 wt % of a styrene-butadiene rubber.

### EXAMPLE 4

A negative electrode was fabricated according to the same method as Example 1 except for using 80 wt % of the amorphous carbon (SC2 manufactured by GS Energy Co., Ltd.) having an aspect ratio (a/b) of 1.86, 14 wt % of Denka black, 3 wt % of carboxylmethyl cellulose, and 3 wt % of a styrene-butadiene rubber.

### EXAMPLE 5

A negative electrode was fabricated according to the same method as Example 1 except for using 88 wt % of the amorphous carbon (SC3 manufactured by GS Energy Co., Ltd.) having an aspect ratio (a/b) of 1.22, 7 wt % of Denka black, 2 wt % of carboxylmethyl cellulose, and 3 wt % of a styrene-butadiene rubber.

### EXAMPLE 6

A negative electrode was fabricated according to the same method as Example 1 except for using 80 wt % of the amorphous carbon (SC3 manufactured by GS Energy Co., Ltd.) having an aspect ratio (a/b) of 1.22, 14 wt % of Denka black, 3 wt % of carboxylmethyl cellulose, and 3 wt % of a styrene-butadiene rubber.

### COMPARATIVE EXAMPLE 1

A negative electrode was fabricated according to the same method as Example 1 except for using 88 wt % of the amorphous carbon (SC1 manufactured by BTR) having an aspect ratio (a/b) of 1, 7 wt % of Denka black, 2 wt % of carboxylmethyl cellulose, and 3 wt % of a styrene-butadiene rubber.

### COMPARATIVE EXAMPLE 2

A negative electrode was fabricated according to the same method as Example 1 except for using 80 wt % of the amorphous carbon (SC1 manufactured by BTR) having an aspect ratio (a/b) of 1, 14 wt % of Denka black, 3 wt % of carboxylmethyl cellulose, and 3 wt % of a styrene-butadiene rubber.

### Evaluation 1: SEM Photograph of Negative Active Material

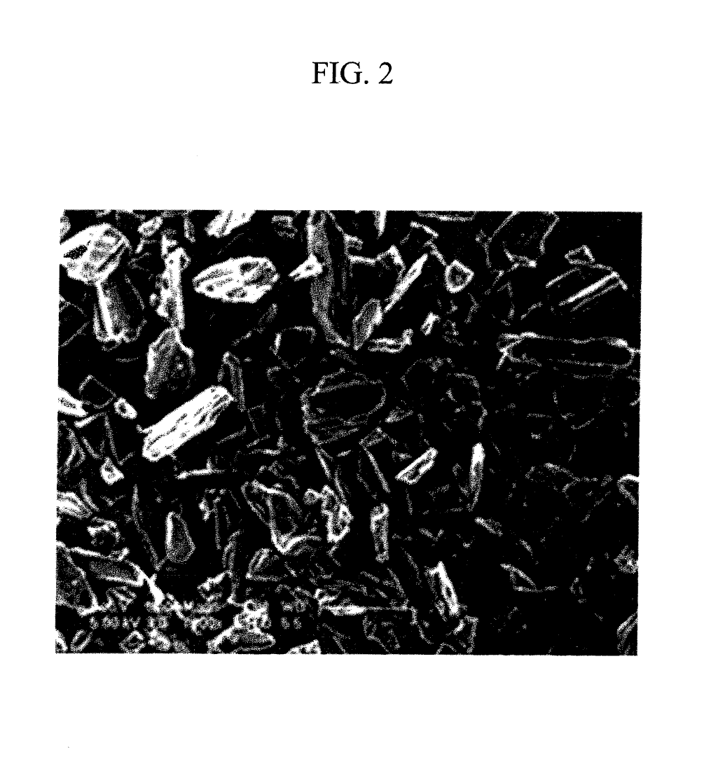

Photographs of the negative active materials used for the negative electrodes according to Examples 1 to 6 and Comparative Examples 1 and 2 were taken using a scanning electronic microscope (SEM). The results are provided in FIGS. 2 to 5.

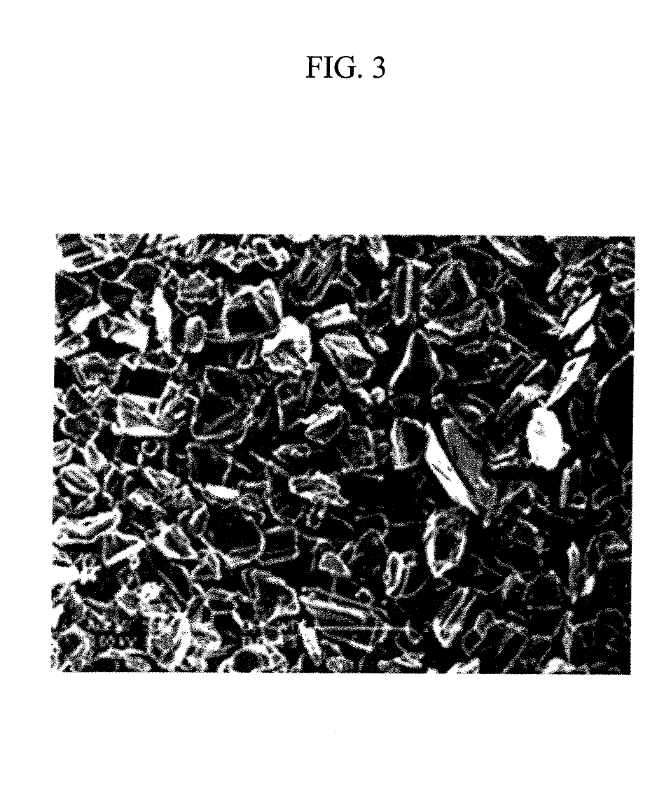

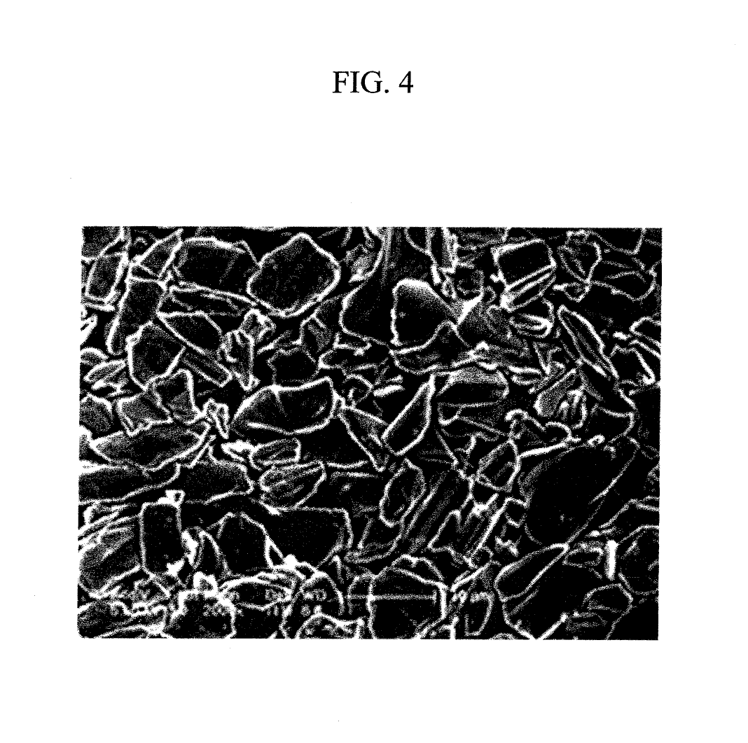

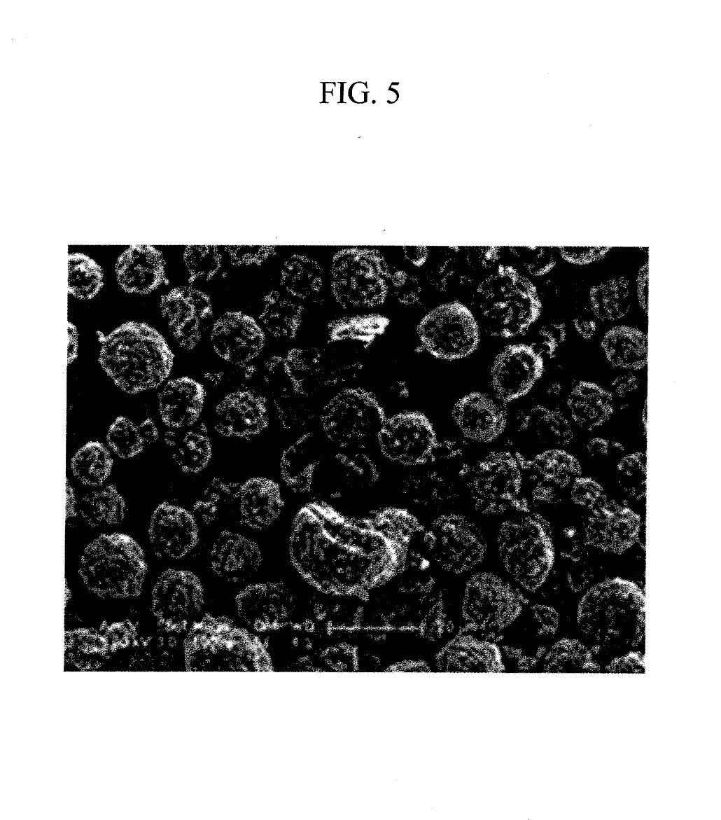

FIG. 2 shows the SEM photograph of the negative active material used in Example 1, FIG. 3 shows the SEM photograph of the negative active material used in Example 3, FIG. 4 shows the SEM photograph of the negative active material used in Example 5, and FIG. 5 shows the SEM photograph of the negative active material used in Comparative Example 1.

Referring to FIGS. 2 to 5, the negative active materials used for the negative electrodes according to Examples 1, 3, and 5 included amorphous carbon having an aspect ratio ranging from 1.2 to 4, while Comparative Example 1 included amorphous carbon having an aspect ratio of 1.

Examples 1-6 and Comparative Examples 1 and 2 were also evaluated to determine interplanar distance d(002), lattice constant (L_{c}), and average particle diameter D(50) of the negative active material. The results are shown below in Table 1.

TABLE 1

| | Aspect | Amount | d(002) | Lc | D(50) |
|---|---|---|---|---|---|
| | Ratio (a/b) | (wt %) | (Å) | (Å) | (μm) |
| Example 1 | 4 | 88 | 3.5 | 18.5 | 10.2 |
| Example 2 | 4 | 80 | 3.5 | 18.5 | 10.2 |
| Example 3 | 1.86 | 88 | 3.5 | 18.5 | 10.1 |
| Example 4 | 1.86 | 80 | 3.5 | 18.5 | 10.1 |
| Example 5 | 1.22 | 88 | 3.5 | 18.5 | 10.2 |
| Example 6 | 1.22 | 80 | 3.5 | 18.5 | 10.2 |
| Comparative | 1 | 88 | 3.5 | 18.5 | 10.4 |
| Example 1 | | | | | |
| Comparative | 1 | 80 | 3.5 | 18.5 | 10.4 |
| Example 2 | | | | | |

### Fabrication of Rechargeable Lithium Battery Cell

A positive electrode was fabricated by mixing 90 wt % of LiCoO₂, 5 wt % of polyvinylidene fluoride, and 5 wt % of Denka black in N-methyl pyrrolidone to prepare a composition for a positive active material layer. The composition was then coated on an aluminum film current collector, dried, and compressed.

A positive electrode, an electrolyte solution, and one of the negative electrode according to Examples 1 to 6 and Comparative Examples 1 and 2 were combined to fabricate a prismatic battery cell. The electrolyte solution was prepared by mixing ethylenecarbonate (EC), ethylmethylcarbonate (EMC), and dimethylcarbonate (DMC) in a volume ratio of 3:3:4. LiPF₆ was then dissolved therein in a concentration of 1.15 M.

### Evaluation 2: Cycle-Life Characteristic of Rechargeable Lithium Battery Cell

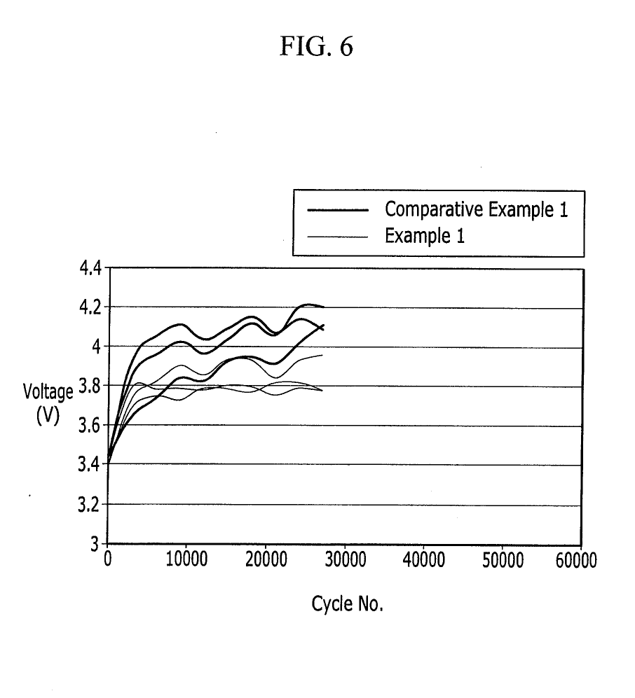

The rechargeable lithium battery cells using the negative electrodes according to Examples 1 to 6 and Comparative Examples 1 and 2 were charged at a rate of 30 C up to 4.2 V or for 20 seconds and discharged at a rate of 30 C down to 2.0 V or for 20 seconds as one cycle. That cycle was repeated 30,000 times. The results are provided in the following Table 2 and FIG. 6.

In the following Table 2, capacity retention (%) of the rechargeable lithium battery cells was obtained as a percentage of discharge capacity at 1000 cycles relative to initial discharge capacity at a rate of 30 C.

TABLE 2

| | Initial discharge | Capacity retention (%) |
|---|---|---|
| | capacity (mAh/g) | at a rate of 30 C |
| Example 1 | 280 | 97 |
| Example 2 | 280 | 96 |
| Example 3 | 280 | 94 |
| Example 4 | 280 | 93 |
| Example 5 | 280 | 93 |
| Example 6 | 280 | 92 |
| Comparative Example 1 | 253 | 88 |
| Comparative Example 2 | 253 | 88 |

Referring to Table 2, Examples 1 to 6 include amorphous carbon having an aspect ratio (a/b) within the above described range. As such, an amorphous carbon negative active material within the above described range, exhibited high cycle-life characteristics compared with Comparative Examples 1 and 2 which used an amorphous carbon negative active material having an aspect ratio (a/b) of 1.

FIG. 6 is a graph showing cycle-life characteristic of three rechargeable lithium battery cells according to each of Example 1 and Comparative Example 1.

Referring to FIG. 6, rechargeable lithium battery cells according to Example 1 had good cycle-life characteristics at a lower voltage and thus, higher capacity and better cycle-life characteristics than those according to Comparative Example 1.

### Evaluation 3: Output Characteristic of Rechargeable Lithium Battery Cell

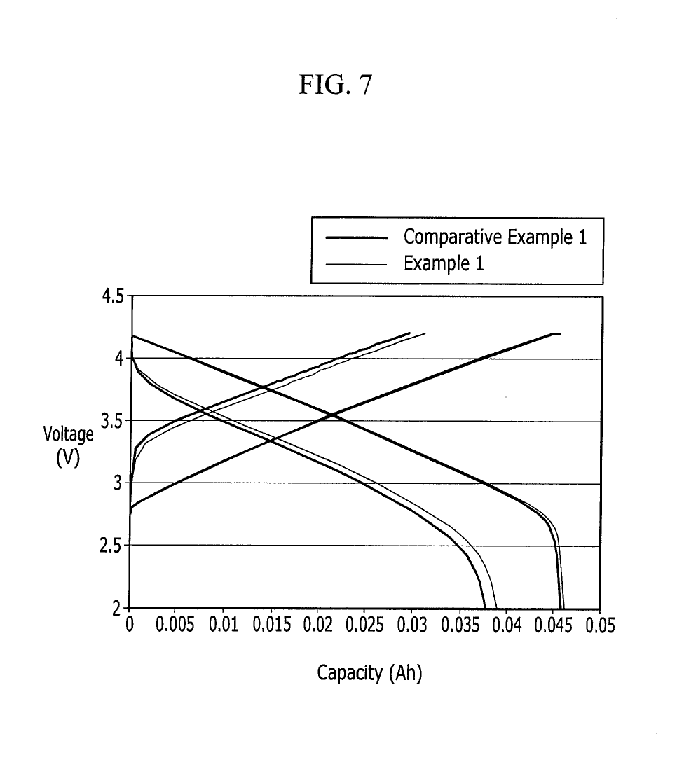

The rechargeable lithium battery cells including the negative electrodes according to Examples 1 to 6 and Comparative Examples 1 and 2 were respectively charged and discharged at a rate of 1 C up to 4.2 V and then, at a rate of 30 C up to 4.2 V. The results are provided in the following Table 3 and FIG. 7.

In the following Table 3, the capacity retention (%) of the rechargeable lithium battery cells at the rate of 1 C was obtained as a percentage of the discharge capacity at the rate of 30 C relative to the discharge capacity at the rate of 1 C.

TABLE 3

| | 30 C/1 C capacity retention (%) |
|---|---|
| Example 1 | 92 |
| Example 2 | 91 |
| Example 3 | 88 |
| Example 4 | 86 |
| Example 5 | 86 |
| Example 6 | 85 |
| Comparative Example 1 | 84 |
| Comparative Example 2 | 83 |

Referring to Table 3, Examples 1 to 6 using amorphous carbon with an aspect ratio (a/b) within the above described range as a negative active material had high output characteristics compared with Comparative Examples 1 and 2 using amorphous carbon with an aspect ratio (a/b) of 1.

FIG. 7 is a graph showing output characteristics of the rechargeable lithium battery cells according to Example 1 and Comparative Example 1.

Referring to FIG. 7, Example 1 had small capacity change at the high rate of 30 C and good high rate characteristics compared with Comparative Example 1.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and equivalents thereof.

What is claimed is:

1. A negative electrode for a rechargeable lithium battery, comprising:
a current collector; and
a negative active material layer on the current collector, the negative active material layer comprising a negative active material comprising amorphous carbon having an average aspect ratio of 1.1 to 6,
wherein the amorphous carbon is included in an amount of about 55.5 wt % to about 99.5 wt % based on the total weight of the negative active material layer.

2. The negative electrode of claim 1, wherein the average aspect ratio of the amorphous carbon is in a range of 3 to 5.

3. The negative electrode of claim 1, wherein the amorphous carbon is included in an amount of about 70.0 wt % to about 95.0 wt % based on the total weight of the negative active material layer.

4. The negative electrode of claim 1, wherein the amorphous carbon has an interplanar distance d(002) in a range of 3.10 Å to 3.55 Å.

5. The negative electrode of claim 4, wherein the interplanar distance d(002) of the amorphous carbon is in a range of 3.40 Å to 3.55 Å.

6. The negative electrode of claim 1, wherein the amorphous carbon has a lattice constant (L_{c}) in a range of 10 Å to 50 Å.

7. The negative electrode of claim 6, wherein the lattice constant (L_{c}) of the amorphous carbon is in a range of 10 Å to 30 Å.

8. The negative electrode of claim 1, wherein the amorphous carbon has an average particle diameter D(50) in a range of 5 μm to 20 μm.

9. The negative electrode of claim 8, wherein the average particle diameter (D(50)) of the amorphous carbon is in a range of 7 μm to 15 μm.

10. The negative electrode of claim 1, wherein the amorphous carbon is soft carbon.

11. The negative electrode of claim 1, wherein the negative active material layer further comprises a conductive material and a binder.

12. A lithium battery comprising:
a negative electrode comprising:
a current collector;
a negative active material layer on the current collector, the negative active material layer comprising a negative active material comprising amorphous carbon having an average aspect ratio of 1.1 to 6,
wherein the amorphous carbon is included in an amount of about 55.5 wt % to about 99.5 wt % based on the total weight of the negative active material layer;
a positive electrode comprising a positive active material; and
an electrolyte impregnating the negative electrode and the positive electrode.

13. The lithium battery of claim 12, wherein the positive active material comprises a material selected from the group consisting of a lithium composite oxide, activated carbon, and combinations thereof.

14. The lithium battery of claim 12, wherein the average aspect ratio of the amorphous carbon is in a range of 3 to 5.

15. The lithium battery of claim 12, wherein the amorphous carbon is included in an amount of about 70.0 wt % to about 95.0 wt % based on the total weight of the negative active material layer.

16. The lithium battery of claim 12, wherein the amorphous carbon has an interplanar distance d(002) in a range of 3.10 Å to 3.55 Å.

17. The lithium battery of claim 12, wherein the amorphous carbon has a lattice constant (L_{c}) in a range of 10 Å to 50 Å.

18. The lithium battery of claim 12, wherein the amorphous carbon has an average particle diameter (D(50)) in a range of 5 μm to 20 μm.

19. The lithium battery of claim 12, wherein the amorphous carbon is soft carbon.

20. The lithium battery of claim 12, wherein the negative active material layer further comprises a conductive material and a binder.
